(19) United States
(12) Patent Application Publication
(10) Pub. No.: US 2024/0149723 A1
(43) Pub. Date: May 9, 2024

(54) METHOD FOR OPERATING A CHARGING STATION DESIGNED AND PROVIDED FOR CHARGING A TRACTION BATTERY OF A MOTOR VEHICLE WITH ELECTRIC ENERGY, THE CORRESPONDING CHARGING STATION, AND A BUILDING ARRANGEMENT HAVING A CHARGING STATION

(71) Applicant: AUDI AG, Ingolstadt (DE)

(72) Inventors: Matthias SCHNEIDER, Schernfeld (DE); Stefan WALTL, Reichertshofen (DE)

(21) Appl. No.: 18/499,767

(22) Filed: Nov. 1, 2023

(30) Foreign Application Priority Data
Nov. 4, 2022 (DE) 102022129145.6

(51) Int. Cl. B60L 53/35; B60L 53/18

(52) U.S. Cl. CPC B60L 53/35; B60L 53/18

(57) ABSTRACT

A method for operating a charging station is provided and configured to charge a traction battery of a motor vehicle with electric energy, wherein the charging station may include a charging cable held by a charging arm of the charging station. Movement of the charging cable and/or a position of a user of the charging station making use of the charging cable may be detected by at least one sensor and the charging arm may be moved in a motorized manner in the direction of the movement of the charging cable and/or in the direction of the position of the user. The disclosure furthermore relates to a charging station for charging a traction battery of a motor vehicle with electric energy as well as a building arrangement having a charging station.

### BACKGROUND

### Technical Field

Embodiments of the invention relate to a method for operating a charging station and to a charging station for charging a traction battery of a motor vehicle.

### Description of the Related Art

DE 2018 004 919 A1 relates to a vehicle charging station for the electrical charging of an energy storage of a vehicle, including a robot arm, by means of which an electrical contact element at the vehicle side can be connected to an electrical contact element at the charging station side in order to make an electric energy transfer connection between the vehicle charging station and the vehicle. For such an electric energy transfer, the vehicle charging station includes a plurality of interchangeable connection heads for the robot arm, wherein this plurality of interchangeable connection heads encompasses the electrical contact element at the charging station side and at least one cleaning function element.

US 2013/0257373 A1 discloses a cable handling device having an elongated arm, which is fastened in a pivoting manner to a base, such that the arm can move in proximity to a charging port. The cable handling device also includes a cable, which is attached to the arm. The cable includes a charging connector which can be brought into engagement with the charging port. The cable has a fixed section, which is secured generally parallel to the elongated arm, and a free section, which extends from a distal end of the elongated arm. The charging port is arranged at one end of the free section. A cantilever support holds the elongated arm in an upwardly directed position, such that the cantilever support lessens the external force needed for the pivoting of the arm. A pivoting zone of the arm arranges the charging connector above the ground level, such that a ground contact of the free section during the engaging of the charging connector and the charging port is avoided.

### BRIEF SUMMARY

The present disclosure provides methods for operating a charging station configured to charge a traction battery of a motor vehicle with electric energy, which enables a comfortable use of the charging station and a simple connecting of the charging cable to the motor vehicle.

Embodiments may include a method for operating a charging station configured to charge a traction battery of a motor vehicle with electric energy. A movement of the charging cable and/or a position of a user of the charging station making use of the charging cable may be detected by at least one sensor and the charging arm may be moved in motorized manner in the direction of the movement of the charging cable and/or in the direction of the position of the user.

The method explained in the course of this specification serves for operating a charging station. The charging station may be configured to charge the traction battery of the motor vehicle with electric energy. The charging station may possess means of producing an electrical connection between the charging station and the traction battery. These means may include the charging cable, which may conductively transmit electric energy. The charging cable may be connected at one end to a base device of the charging station in a permanent manner.

The charging cable may include a charging connector, which may be connected electrically to a charging port of the motor vehicle. The charging connector may be a plug or a socket, and the charging port may accordingly be in the form of a socket or a plug. For the charging of the traction battery, the charging connector may be electrically connected to the motor vehicle by a user of the charging station. After the connection is made, electric current may be provided from the base device of the charging station through the charging cable for the charging of the traction battery such that electric current is transferred to the motor vehicle.

In some embodiments, the charging station may include a parking place for the motor vehicle, on which the user of the charging station may position the motor vehicle. After parking the motor vehicle on the parking place, the conductive electrical connection may be made between the charging station and the motor vehicle, such as by using the charging cable which electrically connects the charging station to the motor vehicle or to the traction battery.

The charging cable may include a heavy weight to account for electric current of considerable strength which may flow through the charging cable. Accordingly, a great effort may be exerted by the user to bring the charging cable from the charging station to the motor vehicle and to attach it to the latter. At least part of the weight of the charging cable must be carried by the user when bringing the charging cable from the charging station to the motor vehicle. In addition, it may be more difficult to make use of the charging station because the charging cable is at least partially lying on a floor or the ground, such that the danger exists of the user tripping over the charging cable. In addition, the charging cable positioned on the ground may become dirty and/or damaged.

For these reasons, the charging station may include the charging arm, which may be rigid. The charging arm may hold or carry the charging cable. The charging arm may be configured such that the charging arm maintains the charging cable at least partially away from the ground. The charging arm may lead the charging cable from the base device to the motor vehicle at a distance from the ground. In some embodiments, the charging arm may be situated at least partially away from the ground, for example, at a height which may be greater than the height of the motor vehicle and/or the physical height of the user.

The charging cable may include a free end, which may protrude beyond the charging arm at the side with the motor vehicle, such that the free end hangs down from the arm, i.e., in the direction toward the ground. The free end of the charging cable includes a portion of the charging cable which extends beyond the charging arm, and consequently that portion of the charging cable extending from the charging arm to the charging connector. The charging cable and/or the charging arm may be configured such that the charging arm spaces the entire free end of the charging cable away from the ground. In such embodiments when the charging cable is hanging down freely from the charging arm, the charging connector of the charging cable may be spaced away from the ground. In such embodiments, the safety and comfort of using the charging station may be significantly improved for the user.

It is known how to equip the charging arm with a return mechanism, which constantly applies a restoring force to the charging arm, forcing it in the direction of a starting position. For the connecting of the charging cable to the motor vehicle in such configurations, the user must apply an operating force to the charging cable such that the charging arm is swiveled out from its starting position against the restoring force. After the charging of the traction battery, the charging connector of the charging cable can be removed from the motor vehicle and the charging cable can be released. Because of the restoring force acting on the charging arm, the charging arm is moved in the direction toward its starting position, preferably into that position, and at the same time the charging cable is carried along, so that this as well is then securely stowed away.

However, with such a configuration of the charging arm, the user must apply a substantial positioning force in order to connect the charging cable electrically to the motor vehicle. To overcome such an application of the positioning force, the present disclosure provides for the charging arm to be moved in motorized manner. The displacement of the charging cable and/or the position of the user may be detected by the at least one sensor. A determination may be made as to whether the user is grabbing the charging cable and exerting the positioning force on the charging cable in order to move the charging cable or its charging connector in the direction of the motor vehicle. The position of the user may be determined.

In some embodiments, the charging arm may be moved in a motorized manner in the direction of the displacement of the charging cable or in the direction of the position of the user, or the charging arm may be oriented in such a direction. In other words, one end of the charging arm may be oriented such that the one end of the charging arm points in the direction of the desired displacement of the charging cable or points in the direction of the position of the user. The motorized displacement may be accomplished by a drive unit of the charging station, which may include an electric motor or the like. In such embodiments, comfortable usage may be provided to the user, since little or no positioning force may be needed in order to move the charging cable in the direction of the motor vehicle or up to the motor vehicle.

Some embodiments of the present disclosure may include the charging arm being configured to travel in linear motion along at least one displacement axis and/or to be rotated about at least one axis of rotation. Linear travel may be the movement of the charging arm along the displacement axis. The displacement axis may be a straight line. The charging arm may travel in linear manner along one displacement axis or it may be moved along this axis. In some embodiments, multiple displacement axes different from each other may be present, along which the charging arm may be moved at least for a time. The multiple displacement axes may be angled relative to each other, i.e., the multiple displacement axes may intersect each other and make an angle with each other which may be larger than 0° and smaller than 180°. In some embodiments, the displacement axes may be perpendicular to each other, such that the mentioned angle is 90°.

The charging arm may be rotated about the at least one axis of rotation during the motorized travel. The rotating may occur about one axis of rotation, or there may be different axes of rotation about which the charging arm can rotate each time, or rotate at least for a time. The multiple axes of rotation may intersect each other and make an angle with each other which may be larger than 0° and smaller than 180°. In some embodiments, the axes of rotation are perpendicular to each other, such that the angle is 90°. With the aid of the linear travel and/or the rotating, a precise adapting of the position of the charging arm to the desires of the user may be accomplished.

In some embodiments, the displacement may occur relative to a base device of the charging station, to which the charging cable may be electrically connected. The base device may be a stationary device of the charging station. The moving of the charging arm relative to the base device may include the base device being stationary and the charging arm being moved at least for a time in relation to the base device. The charging cable may be connected to the base device on its side facing away from the motor vehicle.

The base device may include a display device and/or an operating device. The display device may be configured to show information. The operating device may be configured to receive a manual input from the user. The charging station may present information to the user at least for some of the time by way of the display device. The information may include status information of the charging station. The display device may show the information in text form and/or graphically. In some embodiments, the display device may include a monitor screen or the like. The monitor screen may be an LCD, LED, or OLED monitor screen.

The user may operate the charging station via the operating device. For example, the user may order the charging station to start a charging process or to end the charging process. The operating device may assign one or more charging parameters to the charging station, which may be used during the charging process, such as a charging current to be used for the charging, the quantity of current to be supplied to the traction battery, and/or a target state of charge which the traction battery should have after the charging. In some embodiments, the operating device may initiate and/or carry out a payment procedure.

The charging process may be a process during which the charging station supplies the traction battery with electric energy for charging. Outside of the charging process, the traction battery may not be supplied with electric energy by the charging station, and the electrical connection between the charging station and the traction battery may be broken outside of the charging process. The described procedure may enable a comfortable use for the user.

In some embodiments, the at least one sensor may be configured to be used as at least one of the following sensors: force sensor, torque sensor, acceleration sensor, strain sensor, position sensor, and optical sensor. For example, a force exerted by the user on the charging cable may be measured, as well as its direction, by the force sensor. In some embodiments, the charging arm may be moved in a motorized manner such that the force as detected by the force sensor becomes smaller. In some embodiments, the movement may be performed in the direction of the direction detected by the force sensor. The force sensor may, for example, be arranged on the charging arm and may be in connection with the charging cable.

The torque sensor may detect a torque produced by the user through the charging cable on the charging arm, such as a torque about the axis of rotation. The charging arm may be moved in a motorized manner such that the torque, as detected, becomes smaller. The acceleration sensor may be configured to detect an acceleration acting on the charging cable, such as an acceleration acting on the charging connector. The acceleration sensor may be arranged on the charging cable or on the charging connector of the charging cable in order to detect an acceleration acting on the charging cable. A direction of acceleration will also be detected when the acceleration is detected, and the charging arm will be moved in the acceleration direction.

The strain sensor may be configured to detect a strain of the charging cable, which may be produced, for example, by a bending of the charging cable. Accordingly, the strain may be used to infer the direction in which the user is moving or would like to move the charging cable. Accordingly, the charging arm may be moved in a motorized manner in this direction. The position sensor may be configured to detect a position of the user and/or of the charging connector of the charging cable. The position sensor may be configured, for example, as a sensor strip, such as a line sensor. The position sensor may utilize any of a number of functional principles, such that the position sensor may work capacitively, inductively, or optically.

The optical sensor may be a camera, which may include a CCD sensor. A picture of the surroundings of the charging station may be taken and evaluated in order to determine the position of the user and/or the charging connector. The charging arm may be moved in a motorized manner in the direction of this position and/or pointed toward this position. Once again, comfortable use of the charging station may be achieved for the user in this way.

In some embodiments, the at least one sensor may be arranged on the charging arm, the charging cable, or the base device. The sensor may be situated where it can detect the desired quantity. For example, the force sensor may be arranged on the charging arm such that it may act on the charging cable in order to detect the force acting on the charging cable. The torque sensor may be arranged on the charging arm or between the base device of the charging station and the charging arm. The acceleration sensor may be associated with the charging arm, the charging cable, and/or the charging connector of the charging cable.

The strain sensor may be arranged on the charging cable. The arrangement of the position sensor may be chosen according to its functional principle. In some embodiments, the strain sensor be present on the base device, the charging arm, the charging cable, and/or the charging connector of the charging cable. The optical sensor may be configured to be stationary, such as being associated with the base device of the charging station. In some embodiments, the optical sensor may be arranged on the charging arm. The described configurations seek to provide for exact movement of the charging arm to achieve comfortable use of the charging station.

In some embodiments, the length of a region of the charging cable protruding beyond the charging arm may be changed based on the displacement of the charging cable and/or the position of the user. As described above, the charging cable protrudes beyond the charging arm, and accordingly, the length of the charging cable between the charging arm and the charging connector of the charging cable is greater than zero. Such length may be adapted in combination with the moving of the charging cable, such as by a motorized displacement of the charging cable relative to the charging arm.

In some embodiments, the height of the charging connector may be adjusted in order to arrange the charging connector suitably with respect to the charging port of the motor vehicle. The length of the region of the charging cable, for example, may be less prior to the displacement of the charging cable by the user than after the displacement. Accordingly, the charging cable may be extended from the charging arm during the displacement of the charging cable so that the user has sufficient room for connecting the charging connector of the charging cable to the charging port of the motor vehicle. If after the charging of the traction battery and a releasing of the charging connector from the charging port of the motor vehicle occurs, the charging cable may be configured to be retracted once more, i.e., the length of the protruding region will be decreased. Such a retraction provides, on the one hand, comfortable use of the charging station, and on the other hand, the charging cable will be stowed away so that it does not hamper the user outside of the charging process.

In some embodiments, the charging arm may be configured to be held in a starting position by a locking device. The locking device may be configured to fix the charging arm in the starting position. In some embodiments, when the charging arm is in the starting position, the locking device will be activated and the charging arm will be locked. In such embodiments, an unintentional moving of the charging arm may be prevented. In some embodiments, the locking device may be deactivated only when the displacement of the charging cable by the user or when the user himself is detected, and the charging arm may be released accordingly for the displacement. In some embodiments, the user may first perform an input on the charging station, such as through the previously described input device, in order to release the charging arm by the locking device. The above described configuration may prevent the unintentional movement of the charging arm, which may disturb the user.

Some embodiments relate to a charging station for charging a traction battery of a motor vehicle with electric energy, such as including the method provided in this disclosure, wherein the charging station may include a charging cable, which may be held by a charging arm of the charging station. The charging station may be configured to detect, by at least one sensor, a displacement of the charging cable and/or a position of a user of the charging station making use of the charging cable and to move the charging arm in a motorized manner in the direction of the displacement of the charging cable and/or in the direction of the position of the user.

Some embodiments of the invention relate to a building arrangement having a wall and a charging station arranged on the wall for the charging of a traction battery of a motor vehicle with electric energy, such as a charging station as described herein, wherein the charging station may include a charging cable, which may be held by a charging arm of the charging station. The charging station may be configured to detect, by at least one sensor, a displacement of the charging cable and/or a position of a user of the charging station making use of the charging cable and to move the charging arm in a motorized manner in the direction of the displacement of the charging cable and/or in the direction of the position of the user.

In some embodiments, the charging arm may be configured to be received in at least one position in a recess formed in the wall. The wall may bound an interior of the building arrangement on the outside. The wall may have a wall surface associated with the interior. The recess may pierce this wall surface, such that the recess may be accessible from the interior or the recess may emerge into the interior through a wall opening. The charging arm and the recess may be configured such that the recess for receiving the charging arm is large enough for receiving the charging arm. In some embodiments, the recess may receive the charging arm entirely in the at least one position, such that the charging arm does not stick out past the recess or does not protrude into the interior.

The at least one position may be the starting position. In the starting position, the charging arm may be held or fixed by the locking device. For example, the locking device may lie at a distance from the base device of the charging station, and may be fastened to the wall. In some embodiments, the locking device may be arranged at a distance from the at least one axis of rotation, in order to reliably intercept a torque possibly produced by a drive unit of the charging arm. Such a configuration may improve the safety of the charging station.

The features and combinations of features described in the specification, may be used not only in the particular combination indicated, but also in other combinations or standing alone, without leaving the scope of the disclosure. Thus, embodiments not explicitly shown or explained in the specification and/or the figures, yet emerging from the explained embodiments or being derivable from them, are to be viewed as also encompassed by the disclosure.

### BRIEF DESCRIPTION OF THE SEVERAL VIEWS OF THE DRAWINGS

FIG. 1 shows a schematic representation of a building arrangement having a wall and a charging station arranged on the wall for charging a traction battery of a motor vehicle with electric energy.

FIG. 2 shows a further schematic representation of the building arrangement of FIG. 1.

### DETAILED DESCRIPTION

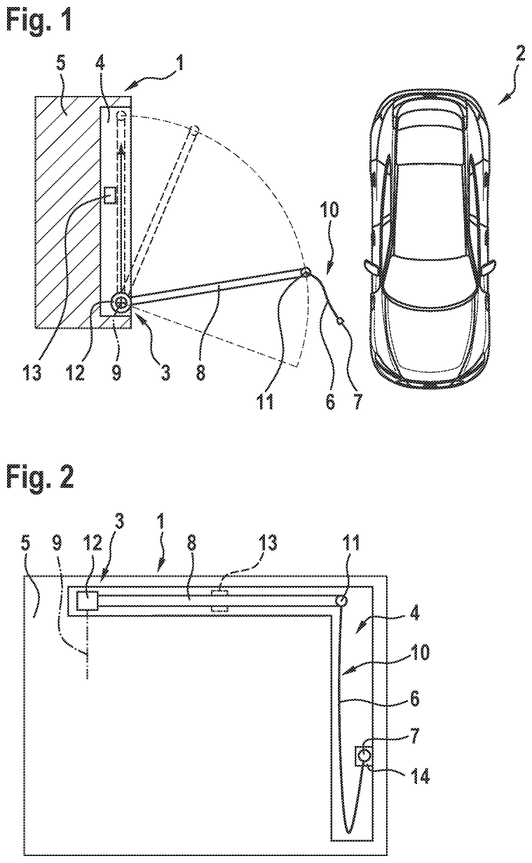

FIG. 1 shows a schematic representation of a building arrangement 1 and a motor vehicle 2. The motor vehicle 2 may include a traction battery (not shown) configured to supply a drive mechanism of the motor vehicle 2 with electric energy. A charging station 3 may be included in the building arrangement 1, as shown in FIG. 1, and may be provided for the charging of the traction battery. The charging station 3 may be situated, at least partially, in a recess 4 which is formed in a wall 5. The charging station 3 may include a charging cable 6, on which a charging connector 7 may be arranged. The charging connector 7 may be connected to a charging port of the motor vehicle 2 to make an electrical connection between the charging station 3 and the motor vehicle 2.

The charging cable 6 may be held by a charging arm 8 of the charging station 3, which is shown in FIG. 1 in three different positions. The charging arm 8 may rotate about an axis of rotation 9. In some embodiments, the charging arm 8 may travel in linear motion along a displacement axis. In some embodiments, the charging arm 8 may be situated at an overhead height, so that it lies above the user and may be easily moved away above the user. In some embodiments, the charging arm 8 may be situated at a height above the ground on which the charging station 3 is situated. The height of the charging arm 8 above the ground may be any of at least 2 m, at least 2.2 m, and at least 2.4 m. The height above the ground of a region of the charging cable 6 arranged on the charging arm 8 may be any of at least 2 m, at least 2.2 m, and at least 2.4 m.

A free end 10 of the charging cable 6 may protrude beyond the charging arm 8 and may extend from the charging arm 8 up to the charging connector 7. The free end 10 may hang down from the charging arm 8 on account of the force of gravity acting on the free end 10. However, the user may grab the free end 10 or the charging connector 7 in order to move the charging cable 6 in the direction of the motor vehicle 2 and may bring the charging connector 7 into engagement with the charging port on the motor vehicle 2.

The charging station 3 may be configured to recognize a displacement of the charging cable 6 by the user and/or a position of the user by at least one sensor 11. The charging station may move the charging arm 8 in the direction of the displacement of the charging cable 6 or in the direction of the position of the user in motorized manner, for example, by rotation about the axis of rotation 9. In other words, the direction of the displacement of the charging cable 6 by the user is recognized and the charging arm 8 is moved in motorized manner in the same direction as the charging cable 6. Such a configuration may simplify the use of the charging station 3 by the user.

A locking device 13 may be provided at a distance from a base device 12 of the charging station 3. The distance may be relative to a distance to which the charging arm 9 may be moved. The locking device 13 may be configured to fix the charging arm 8 in one of the positions discussed herein. The locking device 13 may prevent an unwanted extension of the charging arm 8 from the recess 4.

FIG. 2 shows a further schematic representation of the building arrangement 1. The recess is configured to receive the base device 12, the charging arm 8, and the charging cable 6. The charging cable 6 may be arranged fully in the recess 4 in the at least one position of the charging arm 8. In order to secure the charging connector 7, a holder 14 may be arranged on the wall 5. In some embodiments, the holder 14 may be arranged in the recess 4. The charging cable 6 and/or the charging connector 7 may be suspended from the holder 14 when the charging station 3 is not being used for the charging of the motor vehicle 2 or the traction battery.

In the described configuration of the building arrangement 1 or the charging station 3, the connecting of the charging cable 6 to the motor vehicle 2 may be greatly facilitated for the user by the mechanized movement of the charging arm 8 by a drive device, such as an electric motor.

German patent application no. 10 2022 129145.6, filed Nov. 4, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a charging station configured to charge a traction battery of a motor vehicle with electric energy, the method comprising:
detecting by at least one sensor a displacement of a charging cable of the charging station and/or a position of a user of the charging station making use of the charging cable; and
moving a charging arm of the charging station in a motorized manner in the direction of the displacement of the charging cable and/or in the direction of the position of the user,
wherein the charging cable is held by the charging arm of the charging station.

2. The method according to claim 1, wherein the charging arm travels in a linear motion along at least one displacement axis and/or is rotated about at least one axis of rotation.

3. The method according to claim 1, wherein the displacement of the charging cable occurs relative to a base device of the charging station, and wherein the charging cable is electrically connected to the base device.

4. The method according to claim 1, wherein the at least one sensor is selected from the group consisting of a force sensor, a torque sensor, an acceleration sensor, a strain sensor, a position sensor and an optical sensor.

5. The method according to claim 1, wherein the at least one sensor is arranged on any of the charging arm, the charging cable and the base device.

6. The method according to claim 1, further comprising changing the length of a region of the charging cable protruding beyond the charging arm based on the displacement of the charging cable and/or the position of the user.

7. The method according to claim 1, further comprising holding the charging arm in a starting position by a locking device.

8. A charging station for charging a traction battery of a motor vehicle with electric energy, the charging station comprising:
a charging arm; and
a charging cable, the charging cable held by the charging arm of the charging station,
wherein the charging station is configured to detect, by at least one sensor, a displacement of the charging cable and/or a position of a user of the charging station making use of the charging cable and to move the charging arm in a motorized manner in the direction of the displacement of the charging cable and/or in the direction of the position of the user.

9. A building arrangement comprising a wall and a charging station arranged on the wall for the charging of a traction battery of a motor vehicle with electric energy, wherein the charging station comprises a charging arm and a charging cable, the charging cable held by the charging arm of the charging station, wherein the charging station is configured to detect, by at least one sensor, a displacement of the charging cable and/or a position of a user of the charging station making use of the charging cable and to move the charging arm in motorized manner in the direction of the displacement of the charging cable and/or in the direction of the position of the user.

10. The building arrangement according to claim 9, wherein the charging arm is received in a recess formed in the wall in at least one position.
